(19) United States
(12) Patent Application Publication
(10) Pub. No.: US 2009/0009437 A1
(43) Pub. Date: Jan. 8, 2009

(54) PLASMA DISPLAY PANEL AND PLASMA DISPLAY APPARATUS

(76) Inventors: Sangchul Hwang, Gumi-City (KR); Changhyun Kim, Gumi-City (KR); Bumhee Park, Gumi-City (KR)

Correspondence Address: KED & ASSOCIATES, LLP, P.O. Box 221200, Chantilly, VA, 20153-1200, US

(21) Appl. No.: 11/931,094

(22) Filed: Oct. 31, 2007

(30) Foreign Application Priority Data
Jul. 3, 2007 (KR) 10-2007-0066532

(51) Int. Cl. G09G 3/28; H01J 17/49

(52) U.S. Cl. 345/68; 313/586

(57) ABSTRACT

A plasma display panel and a plasma display apparatus are disclosed. The plasma display panel includes a front substrate, a scan electrode and a sustain electrode positioned parallel to each other on the front substrate, an upper dielectric layer positioned on the scan electrode and the sustain electrode, a rear substrate positioned to be opposite to the front substrate, a barrier rib positioned between the front and rear substrates to partition a discharge cell, and a phosphor layer positioned inside the discharge cell. The upper dielectric layer includes a glass-based material and a first blue pigment. The phosphor layer includes a first phosphor layer emitting red light, a second phosphor layer emitting blue light, and a third phosphor layer emitting green light. The first phosphor layer includes a red pigment.

This application claims the benefit of Korean Patent Application No. 10-2007-0066532 filed on Jul. 3, 2007 which is hereby incorporated by reference.

### BACKGROUND OF THE DISCLOSURE

1. Field of the Disclosure

This document relates to a plasma display panel and a plasma display apparatus.

2. Description of the Related Art

A plasma display apparatus includes a plasma display panel.

The plasma display panel includes a phosphor layer inside discharge cells partitioned by barrier ribs and a plurality of electrodes.

A driving signal is supplied to the electrodes, thereby generating a discharge inside the discharge cells. When the driving signal generates a discharge inside the discharge cells, a discharge gas filled inside the discharge cells generates vacuum ultraviolet rays, which thereby cause phosphors formed inside the discharge cells to emit light, thus displaying an image on the screen of the plasma display panel.

### SUMMARY OF THE DISCLOSURE

In one aspect, a plasma display panel comprises a front substrate, a scan electrode and a sustain electrode positioned parallel to each other on the front substrate, an upper dielectric layer positioned on the scan electrode and the sustain electrode, the upper dielectric layer including a glass-based material and a first blue pigment, a rear substrate positioned to be opposite to the front substrate, a barrier rib that is positioned between the front substrate and the rear substrate and partitions a discharge cell, and a phosphor layer positioned inside the discharge cell, the phosphor layer including a first phosphor layer emitting red light, a second phosphor layer emitting blue light, and a third phosphor layer emitting green light, the first phosphor layer including a red pigment. [

In another aspect, a plasma display panel comprises a front substrate, a scan electrode and a sustain electrode positioned parallel to each other on the front substrate, an upper dielectric layer positioned on the scan electrode and the sustain electrode, the upper dielectric layer including a glass-based material and a Co-based material, a rear substrate positioned to be opposite to the front substrate, a barrier rib that is positioned between the front substrate and the rear substrate and partitions a discharge cell, and a phosphor layer positioned inside the discharge cell, the phosphor layer including a first phosphor layer emitting red light, a second phosphor layer emitting blue light, and a third phosphor layer emitting green light, the first phosphor layer including an iron (Fe)-based material.

In still another aspect, a plasma display apparatus comprises a front substrate including a scan electrode and a sustain electrode positioned parallel to each other, an upper dielectric layer positioned on the scan electrode and the sustain electrode, the upper dielectric layer including a glass-based material and a first blue pigment, a rear substrate on which an address electrode is positioned to intersect the scan electrode and the sustain electrode, a lower dielectric layer positioned on the address electrode, a barrier rib that is positioned between the front substrate and the rear substrate and partitions a discharge cell, and a phosphor layer positioned inside the discharge cell, the phosphor layer including a first phosphor layer emitting red light, a second phosphor layer emitting blue light, and a third phosphor layer emitting green light, the first phosphor layer including a red pigment, wherein a first sustain signal is supplied to the scan electrode and a second sustain signal overlapping the first sustain signal is supplied to the sustain electrode during a sustain period of at least one subfield of a frame.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIGS. 1A and 1B illustrate a structure of a plasma display panel according to an exemplary embodiment;

FIG. 2 illustrates an operation of the plasma display panel according to the exemplary embodiment;

FIG. 3 is a table showing a composition of a phosphor layer;

FIGS. 4A and 4B are graphs showing reflectances depending on a composition of each of first and second phosphor layers, respectively;

FIG. 5 illustrates a composition of an upper dielectric layer;

FIG. 6 is a graph showing color coordinates of the plasma display panel according to the exemplary embodiment;

FIGS. 7A and 7B are graphs showing a reflectance and a luminance of the plasma display panel depending on changes in a content of red pigment, respectively;

FIGS. 8A and 8B are graphs showing a reflectance and a luminance of a plasma display panel depending on changes in a content of second blue pigment, respectively;

FIGS. 9A and 9B illustrate another implementation of a composition of a phosphor layer;

FIGS. 10A and 10B illustrate a reflectance and a luminance of a plasma display panel depending on changes in a content of green pigment, respectively;

FIGS. 11A and 11B are a table and a graph showing characteristics of the plasma display panel depending on a content of first blue pigment;

FIG. 12 illustrates another structure of an upper dielectric layer;

FIG. 13 illustrates another structure of an upper dielectric layer;

FIGS. 14A and 14B illustrate another structure of the plasma display panel according to the exemplary embodiment;

FIG. 15 is a diagram for explaining the overlap of sustain signals; and

FIG. 16 is a diagram for explaining a first maintenance period and a second maintenance period.

### DETAILED DESCRIPTION OF EMBODIMENTS

Reference will now be made in detail embodiments of the invention examples of which are illustrated in the accompanying drawings.

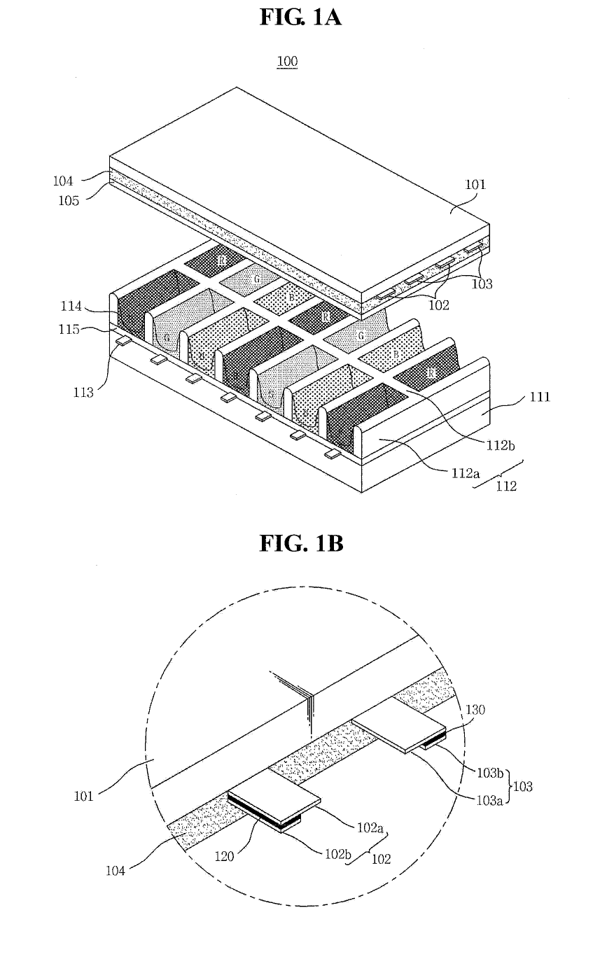

FIGS. 1A and 1B illustrate a structure of a plasma display panel according to an exemplary embodiment.

As illustrated in FIG. 1A, a plasma display panel 100 according to an exemplary embodiment includes a front substrate 101 and a rear substrate 111 which coalesce with each other. On the front substrate 101, a scan electrode 102 and a sustain electrode 103 are positioned parallel to each other. On the rear substrate 111, an address electrode 113 is positioned to intersect the scan electrode 102 and the sustain electrode 103.

An upper dielectric layer 104 is positioned on the scan electrode 102 and the sustain electrode 103 to provide electrical insulation between the scan electrode 102 and the sustain electrode 103.

A protective layer 105 is positioned on the upper dielectric layer 104 to facilitate discharge conditions. The protective layer 105 may include a material having a high secondary electron emission coefficient, for example, magnesium oxide (MgO).

A lower dielectric layer 115 is positioned on the address electrode 113 to provide electrical insulation of the address electrodes 113.

Barrier ribs 112 of a stripe type, a well type, a delta type, a honeycomb type, and the like, are positioned on the lower dielectric layer 115 to partition discharge spaces (i.e., discharge cells). A red (R) discharge cell, a green (G) discharge cell, and a blue (B) discharge cell, and the like, may be positioned between the front substrate 101 and the rear substrate 111. In addition to the red (R), green (G), and blue (B) discharge cells, a white (W) discharge cell or a yellow (Y) discharge cell may be positioned.

Each discharge cell partitioned by the barrier ribs 112 is filled with a discharge gas including xenon (Xe), neon (Ne), and so forth.

A phosphor layer 114 is positioned inside the discharge cells to emit visible light for an image display during the generation of an address discharge. For instance, first, second and third phosphor layer respectively emitting red (R), blue (B) and green (G) light may be positioned inside the discharge cells. In addition to the red (R), green (G) and blue (B) light, a phosphor layer emitting white or yellow light may be positioned.

A thickness of at least one of the phosphor layers 114 formed inside the red (R), green (G) and blue (B) discharge cells may be different from thicknesses of the other phosphor layers. For instance, thicknesses of the second and third phosphor layers inside the blue (B) and green (G) discharge cells may be larger than a thickness of the first phosphor layer inside the red (R) discharge cell. The thickness of the second phosphor layer may be substantially equal or different from the thickness of the third phosphor layer.

Widths of the red (R), green (C), and blue (B) discharge cells may be substantially equal to one another. Further, a width of at least one of the red (R), green (G), or blue (B) discharge cells may be different from widths of the other discharge cells. For instance, a width of the red (R) discharge cell may be the smallest, and widths of the green (G) and blue (B) discharge cells may be larger than the width of the red (R) discharge cell. The width of the green (G) discharge cell may be substantially equal or different from the width of the blue (B) discharge cell. Hence, a color temperature of an image displayed on the plasma display panel can be improved.

The plasma display panel 100 may have various forms of barrier rib structures as well as a structure of the barrier rib 112 illustrated in FIG. 1A. For instance, the barrier rib 112 includes a first barrier rib 112b and a second barrier rib 112a. The barrier rib 112 may have a differential type barrier rib structure in which heights of the first and second barrier ribs 112b and 112a are different from each other.

In the differential type barrier rib structure, a height of the first barrier rib 112b may be smaller than a height of the second barrier rib 112a.

While FIG. 1A has been illustrated and described the case where the red (R), green (G) and blue (B) discharge cells are arranged on the same line, the red (R), green (G) and blue (B) discharge cells may be arranged in a different pattern. For instance, a delta type arrangement in which the red (R), green (G), and blue (B) discharge cells are arranged in a triangle shape may be applicable. Further, the discharge cells may have a variety of polygonal shapes such as pentagonal and hexagonal shapes as well as a rectangular shape.

While FIG. 1A has illustrated and described the case where the barrier rib 112 is formed on the rear substrate 111, the barrier rib 112 may be formed on at least one of the front substrate 101 or the rear substrate 111.

In FIG. 1A, the upper dielectric layer 104 and the lower dielectric layer 115 each have a single-layered structure. However, at least one of the upper dielectric layer 104 or the lower dielectric layer 115 may have a multi-layered structure.

While the address electrode 113 positioned on the rear substrate 111 may have a substantially constant width or thickness, a width or thickness of the address electrode 113 inside the discharge cell may be different from a width or thickness of the address electrode 113 outside the discharge cell. For instance, a width or thickness of the address electrode 113 inside the discharge cell may be larger than a width or thickness of the address electrode 113 outside the discharge cell.

FIG. 1B illustrates another structure of the scan electrode 102 and the sustain electrode 103.

The scan electrode 102 and the sustain electrode 103 may have a multi-layered structure, respectively. For instance, the scan electrode 102 and the sustain electrode 103 each include transparent electrodes 102a and 103a and bus electrodes 102b and 103b.

The bus electrodes 102b and 103b may include a substantially opaque material, for instance, at least one of silver (Ag), gold (Au), or aluminum (Al). The transparent electrodes 102a and 103a may include a substantially transparent material, for instance, indium-tin-oxide (ITO).

Black layers 120 and 130 are formed between the transparent electrodes 102a and 103a and the bus electrodes 102b and 103b to prevent the reflection of external light caused by the bus electrodes 102b and 103b.

The transparent electrodes 102a and 103a may be omitted from the scan electrode 102 and the sustain electrode 103. In other words, the scan electrode 102 and the sustain electrode 103 may be called an ITO-less electrode in which the transparent electrodes 102a and 103a are omitted.

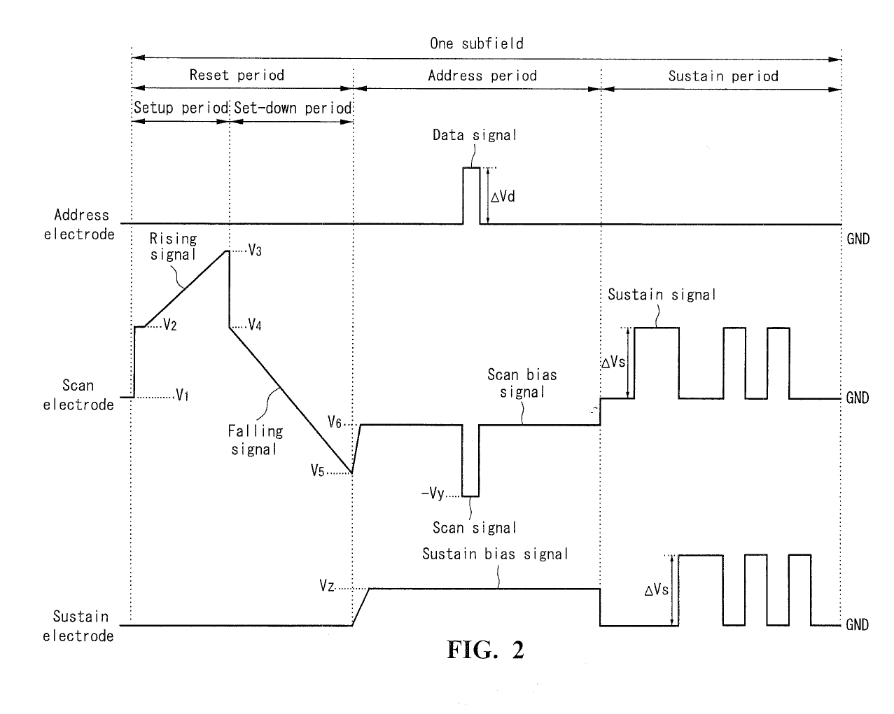

FIG. 2 illustrates an operation of the plasma display panel according to the exemplary embodiment. The exemplary embodiment is not limited to FIG. 2, and an operation method of the plasma display can be variously changed.

As illustrated in FIG. 2, during a reset period for initialization of wall charges, a reset signal is supplied to the scan electrode. The reset signal includes a rising signal and a falling signal. The reset period is further divided into a setup period and a set-down period.

During the setup period, the rising signal with a gradually rising voltage is supplied to the scan electrode. The rising signal generates a weak dark discharge (i.e., a setup discharge) inside the discharge cell during the setup period, thereby accumulating a proper amount of wall charges inside the discharge cell.

During the set-down period, a falling signal of a polarity direction opposite a polarity direction of the rising signal is supplied to the scan electrode. The falling signal generates a weak erase discharge (i.e., a set-down discharge) inside the discharge cell. Furthermore, the remaining wall charges are uniform inside the discharge cells to the extent that an address discharge can be stably performed.

During an address period following the reset period, a scan bias signal, which is maintained at a sixth voltage V6 higher than a lowest voltage of the falling signal, is supplied to the scan electrode.

A scan signal falling from the scan bias signal is supplied to the scan electrode.

A width of a scan signal supplied during an address period of at least one subfield may be different from a width of a scan signal supplied during address periods of the other subfields. For instance, a width of a scan signal in a subfield may be larger than a width of a scan signal in the next subfield in time order. Further, a width of the scan signal may be gradually reduced in the order of 2.6 μs, 2.3 μs, 2.1 μs, 1.9 μs, etc., or in the order of 2.6 μs, 2.3 μs, 2.3 μs, 2.1 μs, . . . , 1.9 μs, 1.9 μs, etc.

As above, when the scan signal is supplied to the scan electrode, a data signal corresponding to the scan signal is supplied to the address electrode.

As the voltage difference between the scan signal and the data signal is added to the wall voltage generated during the reset period, the address discharge occurs within the discharge cell to which the data signal is supplied.

A sustain bias signal is supplied to the sustain electrode during the address period to prevent the generation of the unstable address discharge by interference of the sustain electrode Z.

The sustain bias signal is substantially maintained at a sustain bias voltage Vz. The sustain bias voltage Vz is lower than a voltage Vs of a sustain signal and is higher than the ground level voltage GND.

During a sustain period following the address period, a sustain signal is alternately supplied to the scan electrode and the sustain electrode.

As the wall voltage within the discharge cell selected by performing the address discharge is added to the sustain voltage Vs of the sustain signal, every time the sustain signal is supplied, the sustain discharge, i.e., a display discharge occurs between the scan electrode and the sustain electrode.

A plurality of sustain signals are supplied during a sustain period of at least one subfield, and a width of at least one of the plurality of sustain signals may be different from widths of the other sustain signals. For instance, a width of a first supplied sustain signal among the plurality of sustain signals may be larger than widths of the other sustain signals. Hence, a sustain discharge can be more stable.

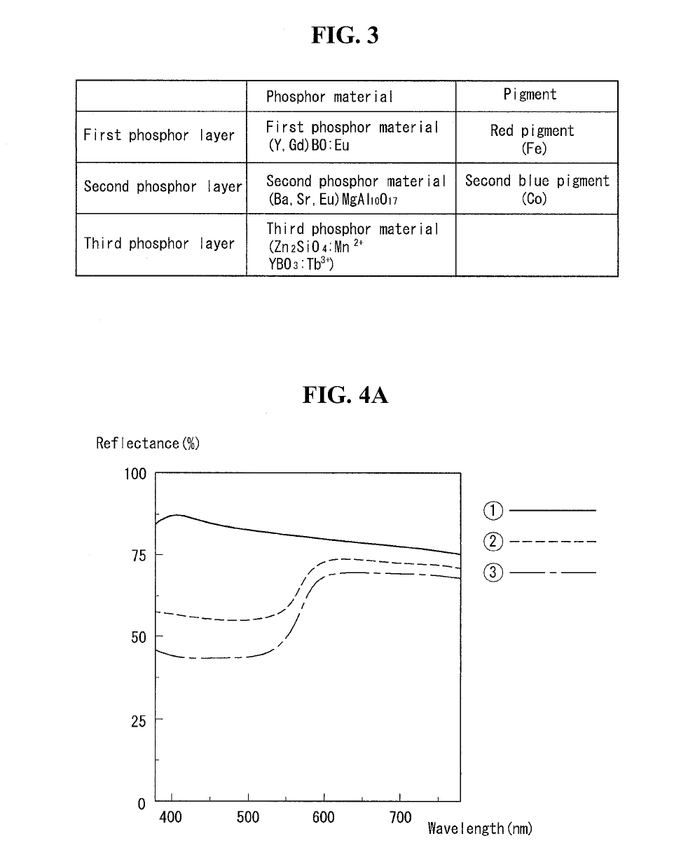

FIG. 3 is a table showing a composition of a phosphor layer.

As illustrated in FIG. 3, a first phosphor layer emitting red light may include a first phosphor material having a white-based color and a red pigment.

The first phosphor material is not particularly limited except the red light emission. The first phosphor material may be (Y, Gd)BO:Eu in consideration of an emitting efficiency of red light.

The red pigment has a red-based color. The first phosphor layer may have a red-based color by mixing the red pigment with the first phosphor material. The red pigment is not particularly limited except the red-based color. The red pigment may include an iron (Fe)-based material in consideration of facility of powder manufacture, color, and manufacturing cost.

The Fe-based material may be a state of iron oxide in the first phosphor layer. For instance, the Fe-based material may be a state of αFe₂O₃ in the first phosphor layer.

The red pigment may include CdSe, CdS, and the like, in addition to the Fe-based material.

As above, when the first phosphor layer includes the red pigment, the red pigment absorbs light coming from the outside. Hence, a reflectance of the plasma display panel can be reduced and a contrast characteristic can be improved.

A second phosphor layer emitting blue light may include a second phosphor material having a white-based color and a second blue pigment so as to further improve the contrast characteristic. The second blue pigment may be omitted.

The second phosphor material is not particularly limited except the blue light emission. The second phosphor material may be (Ba, Sr, Eu)MgAl₁₀O₁₇ in consideration of an emitting efficiency of blue light.

The second blue pigment has a blue-based color. The second phosphor layer may have a blue-based color by mixing the blue pigment with the second phosphor material. The second blue pigment is not particularly limited except the blue-based color. The second blue pigment may include at least one of a cobalt (Co)-based material, a copper (Cu)-based material, a chrome (Cr)-based material, a nickel (Ni)-based material, an aluminum (Al)-based material, a titanium (Ti)-based material or a neodymium (Nd)-based material, in consideration of facility of powder manufacture, color, and manufacturing cost.

At least one of the Co-based material, the Cu-based material, the Cr-based material, the Ni-based material, the Al-based material, the Ti-based material or the Nd-based material may be a state of metal oxide in the second phosphor layer. For instance, the Co-based material may be a state of CoAl₂O₄ in the second phosphor layer.

A third phosphor layer emitting green light includes a third phosphor material having a white-based color, and may not include a pigment.

The third phosphor material is not particularly limited except the green light emission. The third phosphor material may include Zn₂SiO₄:Mn⁺² and YBO₃:Tb⁺³ in consideration of an emitting efficiency of green light.

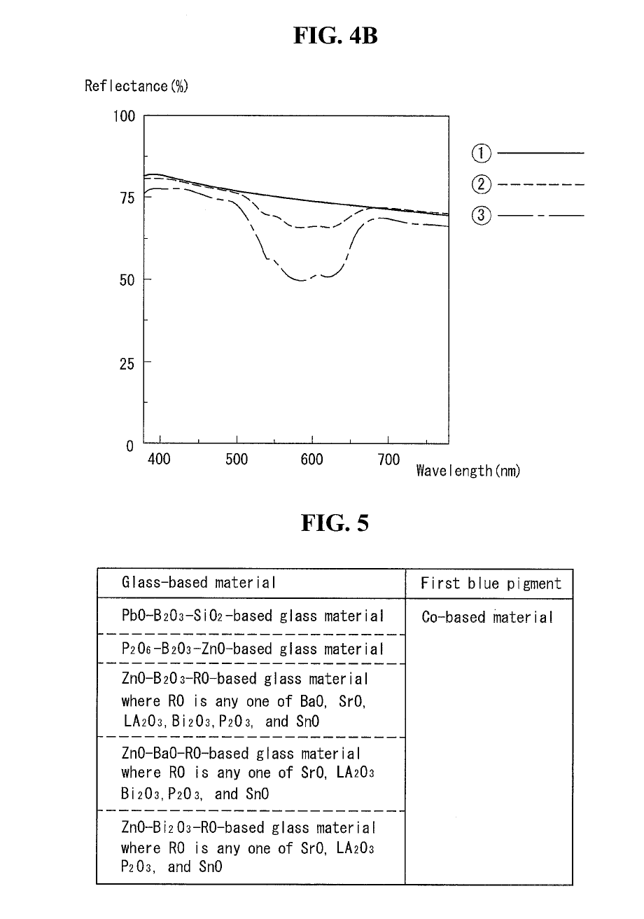

FIG. 4A is a graph showing a reflectance of a test model depending on a wavelength.

First, a 7-inch test model on which a first phosphor layer emitting red light from all discharge cells is positioned is manufactured. Then, light is directly irradiated on a barrier rib and the first phosphor layer of the test model in a state where a front substrate of the test model is removed to measure a reflectance of the test model.

The first phosphor layer includes a first phosphor material and a red pigment. The first phosphor material is (Y, Gd)BO:Eu. The red pigment is an Fe-based material, and the Fe-based material in a state of αFe₂O₃ is mixed with the first phosphor material.

In FIG. 4A, \textcircled{1} indicates a case where the first phosphor layer does not include the red pigment. \textcircled{2} indicates a case where the first phosphor layer includes the red pigment of 0.1 part by weight. \textcircled{3} indicates a case where the first phosphor layer includes the red pigment of 0.5 part by weight.

In case of \textcircled{1} not including the red pigment, a reflectance is equal to or more than about 75% at a wavelength of 400 nm to 750 nm. Because the first phosphor material having a white-based color reflects most of incident light, the reflectance in \textcircled{1} is high.

In case of \textcircled{2} including the red pigment of 0.1 part by weight, a reflectance is equal to or less than about 60% at a wavelength of 400 nm to 550 nm and ranges from about 60% to 75% at a wavelength more than 550 nm.

In case of \textcircled{3} including the red pigment of 0.5 part by weight, a reflectance is equal to or less than about 50% at a wavelength of 400 nm to 550 nm and ranges from about 50% to 70% at a wavelength more than 550 nm.

Because the red pigment having a red-based color absorbs incident light, the reflectances in \textcircled{2} and \textcircled{3} are less than the reflectance in \textcircled{1}.

FIG. 4B is a graph showing a reflectance of a test module depending on a wavelength. First, a 7-inch test model on which a second phosphor layer emitting blue light from all discharge cells is positioned is manufactured. Then, light is directly irradiated on a barrier rib and the second phosphor layer of the test model in a state where a front substrate of the test model is removed to measure a reflectance of the test model.

The second phosphor layer includes a second phosphor material and a second blue pigment. The second phosphor material is (Ba, Sr, Eu)MgAl₁₀O₁₇. The second blue pigment is a Co-based material, and the Co-based material in a state of CoAl₂O₄ is mixed with the second phosphor material.

In FIG. 4B, \textcircled{1} indicates a case where the second phosphor layer does not include the second blue pigment. \textcircled{2} indicates a case where the second phosphor layer includes the second blue pigment of 0.1 part by weight. \textcircled{3} indicates a case where the second phosphor layer includes the second blue pigment of 1.0 part by weight.

In case of \textcircled{1} not including the second blue pigment, a reflectance is equal to or more than about 72% at a wavelength of 400 nm to 750 nm. Because the second phosphor material having a white-based color reflects most of incident light, the reflectance in \textcircled{1} is high.

In case of \textcircled{2} including the second blue pigment of 0.1 part by weight, a reflectance is equal to or more than about 74% at a wavelength of 400 nm to 510 nm, falls to about 60% at a wavelength of 510 nm to 650 nm, and rises to about 72% at a wavelength more than 650 nm.

In case of \textcircled{3} including the second blue pigment of 1.0 part by weight, a reflectance is at least 50% at a wavelength of 510 nm to 650 nm.

Because the second blue pigment having a blue-based color absorbs incident light, the reflectances in \textcircled{2} and \textcircled{3} are less than the reflectance in \textcircled{1}. A reduction in the reflectance can improve the contrast characteristic, and thus the image quality can be improved.

A method of manufacturing the first phosphor layer will be described below as an example of a method of manufacturing the phosphor layer.

First, a powder of the first phosphor material including (Y, Gd)BO:Eu and a powder of the red pigment including αFe₂O₃ are mixed with a binder and a solvent to form a phosphor paste. In this case, the red pigment of a state mixed with gelatin may be mixed with the binder and the solvent. A viscosity of the phosphor paste may range from about 1,500 CP to 30,000 CP. An additive such as surfactant, silica, dispersion stabilizer may be added to the phosphor paste, as occasion demands.

The binder used may be ethyl cellulose-based or acrylic resin-based binder or polymer-based binder such as PMA or PVA. However, the binder is not particularly limited thereto. The solvent used may use α-terpineol, butyl carbitol, diethylene glycol, methyl ether, and so forth. However, the solvent is not particularly limited thereto.

The phosphor paste is coated inside the discharge cells partitioned by the barrier ribs. Then, a drying or firing process is performed on the coated phosphor paste to form the first phosphor layer.

FIG. 5 illustrates a composition of an upper dielectric layer.

As illustrated in FIG. 5, an upper dielectric layer includes a glass-based material and a first blue pigment, and has a blue-based color due to the first blue pigment.

The glass-based material is not particularly limited. The glass-based material may be any one of PbO—B₂O₃—SiO₂-based glass material, P₂O₆—B₂O₃—ZnO-based glass material, ZnO—B₂O₃—RO-based glass material (where RO is any one of BaO, SrO, La₂O₃, Bi₂O₃, P₂O₃ and SnO), ZnO—BaO—RO-based glass material (where RO is any one of SrO, La₂O₃, Bi₂O₃, P₂O₃ and SnO), and ZnO—Bi₂O₃—RO-based glass material (where RO is any one of SrO, La₂O₃, P₂O₃ and SnO), or a mixture of at least two of the above glass-based materials.

The first blue pigment included in the upper dielectric layer is not particularly limited except that the upper dielectric layer has a blue-based color. The first blue pigment may include at least one of a cobalt (Co)-based material, a copper (Cu)-based material, a chrome (Cr)-based material, a nickel (Ni)-based material, an aluminum (Al)-based material, a titanium (Ti)-based material, a cerium (Ce)-based material, a manganese (Mn)-based material or a neodymium (Nd)-based material, in consideration of the facility of powder manufacture, the color, and the manufacturing cost.

An example of a method of manufacturing the upper dielectric layer is as follows.

First, a glass-based material and a first blue pigment are mixed. For instance, P₂O₆—B₂O₃—ZnO-based glass material and the first blue pigment are mixed.

A glass is manufactured using the glass-based material mixed with the first blue pigment. In this case, a blue glass having a blue-based color due to the Co-based material is manufactured.

The manufactured blue glass is grinded to manufacture a blue glass powder. The particle size of the blue glass powder may range from about 0.1 μm to 10 μm.

The blue glass powder is mixed with a binder, a solvent, and the like, to manufacture a dielectric paste. An additive such as a dispersion stabilizer may be added to the dielectric paste.

The dielectric paste is coated on the front substrate on which the scan electrode and the sustain electrode are formed. Then, the coated dielectric paste is dried and fired to form the upper dielectric layer.

Accordingly, the upper dielectric layer manufactured using the above manufacturing method can have a blue-based color.

Since the above description is only one example of the manufacturing method of the upper dielectric layer, the exemplary embodiment is not limited thereto. For instance, the upper dielectric layer may be manufactured using a laminating method.

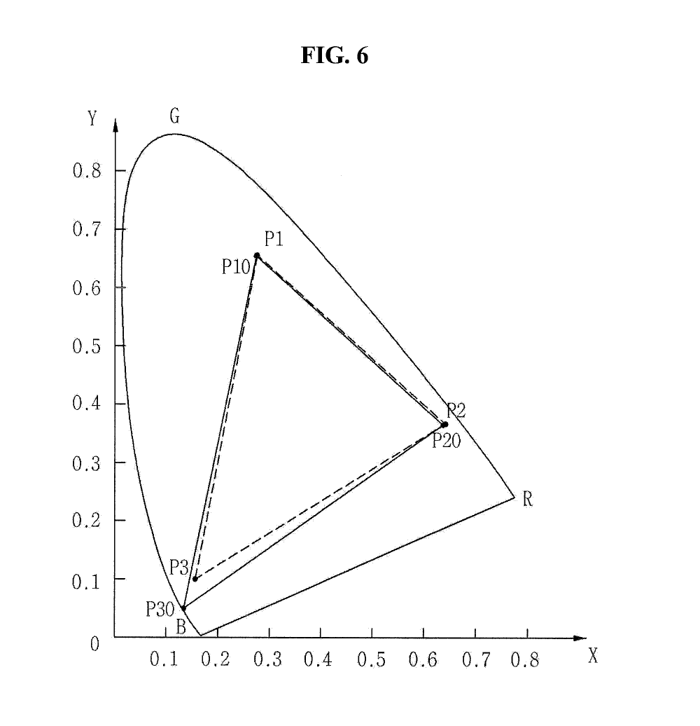

FIG. 6 is a graph showing color coordinates of the plasma display panel according to the exemplary embodiment.

A 1-typed panel in which an upper dielectric layer includes a glass-based material and a Co-based material of 0.2 part by weight as a first blue pigment and a first phosphor layer includes a Fe-based material of 0.2 part by weight as a red pigment, and a 2-typed panel in which an upper dielectric layer includes a glass-based material and does not include a pigment and a first phosphor layer includes a Fe-based material of 0.2 part by weight as a red pigment are manufactured. Then, color coordinates are measured using a photodetector (MCPD-1000) in a state where the same driving signal is supplied to the 1-typed and 2-typed panels.

As illustrated in FIG. 6, in the 2-typed panel, a green coordinate P1 has X-axis coordinate of about 0.276 and Y-axis coordinate of about 0.656; a red coordinate P2 has X-axis coordinate of about 0.642 and Y-axis coordinate of about 0.367; and a blue coordinate P3 has X-axis coordinate of about 0.157 and Y-axis coordinate of about 0.100.

In the 1-typed panel, a green coordinate P10 has X-axis coordinate of about 0.274 and Y-axis coordinate of about 0.655; a red coordinate P20 has X-axis coordinate of about 0.637 and Y-axis coordinate of about 0.360; and a blue coordinate P30 has X-axis coordinate of about 0.135 and Y-axis coordinate of about 0.050.

It can be seen from FIG. 6 that a triangle formed by connecting the coordinates P1, P2 and P3 of the 2-typed panel leans toward a red direction. This means that an image displayed on the 2-typed panel appears red because the first phosphor layer includes a first phosphor material and the red pigment. Therefore, a color temperature of the displayed image is reduced, and a viewer may think that the displayed image is not clear.

On the contrary, as can be seen from FIG. 6, a triangle formed by connecting the coordinates P10, P20 and P30 of the 1-typed panel leans toward a blue direction as compared with the triangle formed by connecting the coordinates P1, P2 and P3 of the 2-typed panel. Because the upper dielectric layer includes the first blue pigment, blue visible light in visible light transmitting the upper dielectric layer is clearer than the other visible light. Hence, a color temperature of the 1-typed panel is higher than a color temperature of the 2-typed panel. Further, a viewer may think that an image displayed on the 1-typed panel is clearer than the image displayed on the 2-typed panel.

In other words, while a color temperature of a displayed image may be reduced due to the red pigment, the first blue pigment can compensate for a reduction in the color temperature caused by the red pigment.

When a second phosphor layer includes a second blue pigment, the color temperature can be further improved.

When the upper dielectric layer includes the Co-based material as the first blue pigment and has a blue-based color, the upper dielectric layer can absorb light coming from the outside. Hence, a panel reflectance can be reduced and a contrast characteristic can be improved.

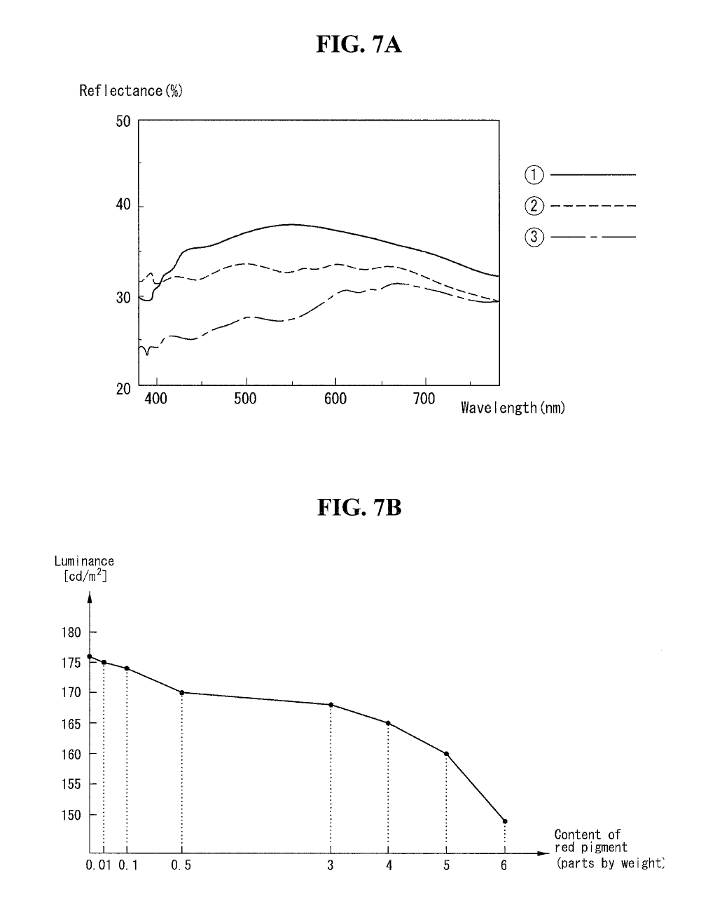

FIGS. 7A and 7B are graphs showing a reflectance and a luminance of the plasma display panel depending on changes in a content of red pigment, respectively.

In FIGS. 7A and 7B, the first phosphor layer is positioned inside the red discharge cell, the second phosphor layer is positioned inside the blue discharge cell, and the third phosphor layer is positioned inside the green discharge cell. Further, a reflectance and a luminance of the plasma display panel are measured depending on changes in a content of red pigment mixed with the first phosphor layer in a state where a second blue pigment of 1.0 part by weight is mixed with the second phosphor layer. In this case, a reflectance and a luminance of the plasma display panel are measured in a panel state in which the front substrate and the rear substrate coalesce with each other.

The first phosphor material is (Y, Gd)BO:Eu. The red pigment is an Fe-based material, and the Fe-based material in a state of αFe₂O₃ is mixed with the first phosphor material.

The second phosphor material is (Ba, Sr, Eu)MgAl₁₀O₁₇. The second blue pigment is a Co-based material, and the Co-based material in a state of CoAl₂O₄ is mixed with the second phosphor material.

In FIG. 7A, \textcircled{1} indicates a case where the first phosphor layer does not include the red pigment in a state where the second phosphor layer includes the second blue pigment of 1.0 part by weight. \textcircled{2} indicates a case where the first phosphor layer includes the red pigment of 0.1 part by weight in a state where the second phosphor layer includes the second blue pigment of 1.0 part by weight. \textcircled{3} indicates a case where the first phosphor layer includes the red pigment of 0.5 part by weight in a state where the second phosphor layer includes the second blue pigment of 1.0 part by weight.

In case of \textcircled{1} not including the red pigment, a panel reflectance rises from about 33% to 38% at a wavelength of 400 nm to 550 nm. A panel reflectance falls to about 33% at a wavelength more than 550 nm. In other words, a panel reflectance has a high value of about 37% to 38% at a wavelength of 500 nm to 600 nm.

Because the first phosphor material having a white-based color reflects most of incident light, the panel reflectance in \textcircled{1} is relatively high although the second blue pigment is mixed with the second phosphor layer.

In case of \textcircled{2} including the red pigment of 0.1 part by weight, a panel reflectance is equal to or less than about 34% at a wavelength of 400 nm to 750 nm, and has a relatively small value of about 33% to 34% at a wavelength of 500 nm to 600 nm.

In case of \textcircled{3} including the red pigment of 0.5 part by weight, a panel reflectance ranges from about 24% to 31.5% at a wavelength of 400 nm to 650 nm and falls to about 30% at a wavelength of 650 nm to 750 nm. Further, a panel reflectance has a relatively small value of about 27.5% to 25.5% at a wavelength of 500 nm to 600 nm.

As above, as a content of red pigment increases, the panel reflectance decreases.

There is a relatively great difference between the panel reflectance in \textcircled{1} not including the red pigment and the panel reflectance in \textcircled{2} and \textcircled{3} including the red pigment at a wavelength of 500 nm to 600 nm.

Because a wavelength of 500 nm to 600 nm mainly appears red, orange and yellow in visible light, a high panel reflectance at a wavelength of 500 nm to 600 nm means that a displayed image is close to red. In this case, because a color temperature is relatively low, a viewer may easily feel eyestrain and an image may be not clear.

On the other hand, a low panel reflectance at a wavelength of 500 nm to 600 nm, for instance, at a wavelength of 550 nm means that absorptance of red, orange and yellow light is high. Hence, a color temperature of a displayed image is relatively high, and thus an image can be clearer.

Accordingly, the relatively great difference between the panel reflectance in \textcircled{1} and the panel reflectance in \textcircled{2} and \textcircled{3} at a wavelength of 500 nm to 600 nm means that an excessive reduction in the color temperature can be prevented by mixing the red pigment with the first phosphor layer. Hence, the viewer can watch a clearer image.

Considering the description of FIG. 7A, a color temperature of the panel can be improved by setting the panel reflectance to be equal to or less than 30% at a wavelength of 500 nm to 600 nm, for instance, at a wavelength of 550 nm.

FIG. 7B is a graph showing a luminance of the same image depending on changes in a content of red pigment included in the first phosphor layer in a state where a content of second blue pigment included in the second phosphor layer is fixed.

As illustrated in FIG. 7B, a luminance of an image displayed when the first phosphor layer does not include the red pigment is about 176 cd/m².

When a content of red pigment is 0.01 part by weight, a luminance of the image is reduced to about 175 cd/m². The reason why the red pigment reduces the luminance of the image is that particles of the red pigment cover a portion of the particle surface of the first phosphor material, thereby hindering ultraviolet rays generated by a discharge inside the discharge cell from being irradiated on the particles of the first phosphor material.

When a content of red pigment ranges from 0.1 to 3 parts by weight, a luminance of the image ranges from about 168 cd/m² to 174 cd/m².

When a content of red pigment ranges from 3 to 5 parts by weight, a luminance of the image ranges from about 160 cd/m² to 168 cd/m².

When a content of red pigment is equal to or more than 6 parts by weight, a luminance of the image is sharply reduced to a value equal to or less than about 149 cd/M². In other words, when a large amount of red pigment is mixed, the particles of the red pigment cover a large area of the particle surface of the first phosphor material and thus the luminance is sharply reduced.

Considering the description of FIGS. 7A and 7B, a content of red pigment may range from 0.01 to 5 parts by weight so as to prevent a reduction in the luminance while the panel reflectance is reduced. A content of red pigment may range from 0.1 to 3 parts by weight.

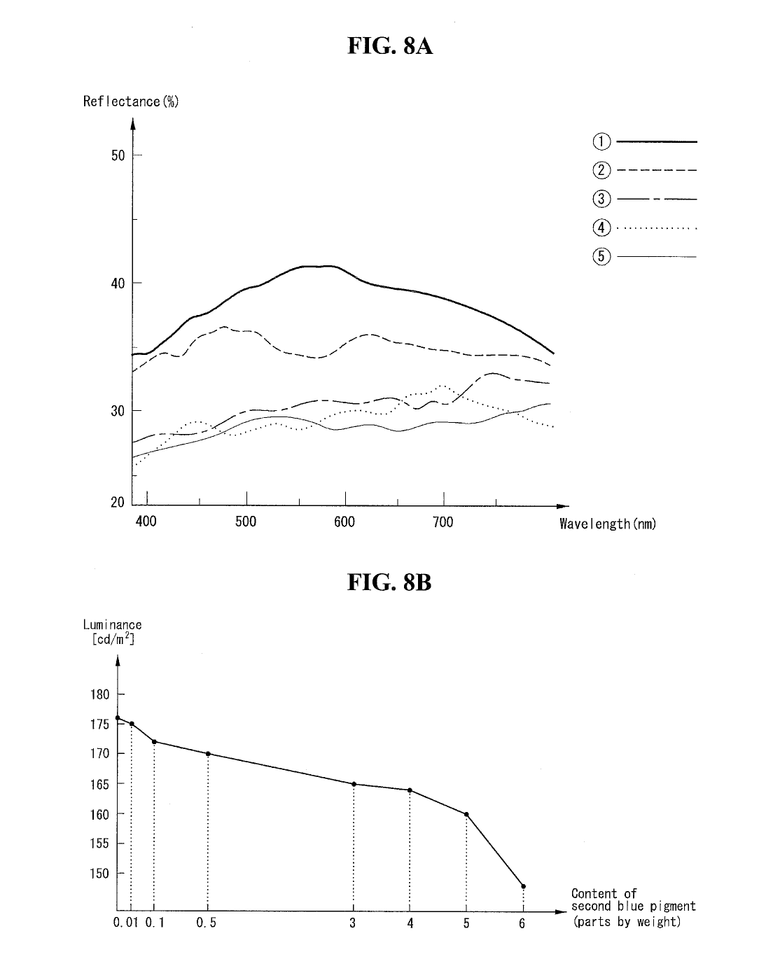

FIGS. 8A and 8B are graphs showing a reflectance and a luminance of a plasma display panel depending on changes in a content of second blue pigment, respectively. A description in FIGS. 8A and 8B overlapping the description in FIGS. 7A and 7B is briefly made or entirely omitted.

In FIGS. 8A and 8B, the first phosphor layer is positioned inside the red discharge cell, the second phosphor layer is positioned inside the blue discharge cell, and the third phosphor layer is positioned inside the green discharge cell. Further, a reflectance and a luminance of the plasma display panel are measured depending on changes in a content of second blue pigment mixed with the second phosphor layer in a state where the red pigment of 0.2 part by weight is mixed with the first phosphor layer. In this case, a reflectance and a luminance of the plasma display panel are measured in a panel state in which the front substrate and the rear substrate coalesce with each other. The other experimental conditions in FIGS. 8A and 8B are the same as the experimental conditions in FIGS. 7A and 7B.

In FIG. 8A, \textcircled{1} indicates a case where the second phosphor layer does not include the second blue pigment in a state where the first phosphor layer includes the red pigment of 0.2 part by weight. \textcircled{2} indicates a case where the second phosphor layer includes the second blue pigment of 0.1 part by weight in a state where the first phosphor layer includes the red pigment of 0.2 part by weight. \textcircled{3} indicates a case where the second phosphor layer includes the second blue pigment of 0.5 part by weight in a state where the first phosphor layer includes the red pigment of 0.2 part by weight. \textcircled{4} indicates a case where the second phosphor layer includes the second blue pigment of 3 parts by weight in a state where the first phosphor layer includes the red pigment of 0.2 part by weight. \textcircled{5} indicates a case where the second phosphor layer includes the second blue pigment of 7 parts by weight in a state where the first phosphor layer includes the red pigment of 0.2 part by weight.

In case of \textcircled{1} not including the second blue pigment, a panel reflectance rises from about 35% to 40.5% at a wavelength of 400 nm to 550 nm. A panel reflectance falls to about 35.5% at a wavelength more than 550 nm. In other words, a panel reflectance has a high value of about 39% to 40.5% at a wavelength of 500 nm to 600 nm.

Because the second phosphor material having a white-based color reflects most of incident light, the panel reflectance in \textcircled{1} is relatively high although the red pigment is mixed with the first phosphor layer.

In case of \textcircled{2} including the second blue pigment of 0.1 part by weight, a panel reflectance is equal to or less than about 38% at a wavelength of 400 nm to 750 nm, and has a relatively small value of about 34% to 37% at a wavelength of 500 nm to 600 nm.

In case of \textcircled{3} including the second blue pigment of 0.5 part by weight, a panel reflectance ranges from about 26% to 29% at a wavelength of 400 nm to 650 nm and falls from about 28% to 32.5% at a wavelength of 650 nm to 750 nm. Further, a panel reflectance has a relatively small value of about 28% to 29% at a wavelength of 500 nm to 600 nm.

In case of \textcircled{4} including the second blue pigment of 3 parts by weight, a panel reflectance ranges from about 22.5% to 29% at a wavelength of 400 nm to 650 nm and ranges from about 29% to 31% at a wavelength of 650 nm to 750 nm. Further, a panel reflectance has a relatively small value of about 26.5% to 28% at a wavelength of 500 nm to 600 nm.

In case of \textcircled{5} including the second blue pigment of 7 parts by weight, a panel reflectance ranges from about 25% to 28% at a wavelength of 400 nm to 700 nm and ranges from about 28% to 30% at a wavelength more than 700 nm.

FIG. 8B is a graph showing a luminance of the same image depending on changes in a content of second blue pigment included in the second phosphor layer in a state where a content of red pigment included in the first phosphor layer is fixed.

As illustrated in FIG. 8B, a luminance of an image displayed when the second phosphor layer does not include the second blue pigment is about 176 cd/m².

When a content of second blue pigment is 0.01 part by weight, a luminance of the image is about 175 cd/m².

When a content of second blue pigment is 0.1 part by weight, a luminance of the image is about 172 cd/m².

When a content of second blue pigment ranges from 0.5 to 4 parts by weight, a luminance of the image has a stable value of about 164 cd/m² to 170 cd/m².

When a content of second blue pigment ranges from 4 to 5 parts by weight, a luminance of the image ranges from about 160 cd/m² to 164 cd/m².

When a content of second blue pigment exceeds 6 parts by weight, a luminance of the image is sharply reduced to a value equal to or less than about 148 cd/m². In other words, when a large amount of second blue pigment is mixed, particles of the second blue pigment cover a large area of the particle surface of the second phosphor material and thus the luminance is sharply reduced.

Considering the description of FIGS. 8A and 8B, a content of second blue pigment may range from 0.01 to 5 parts by weight so as to prevent a reduction in the luminance while the panel reflectance is reduced. A content of second blue pigment may range from 0.5 to 4 parts by weight.

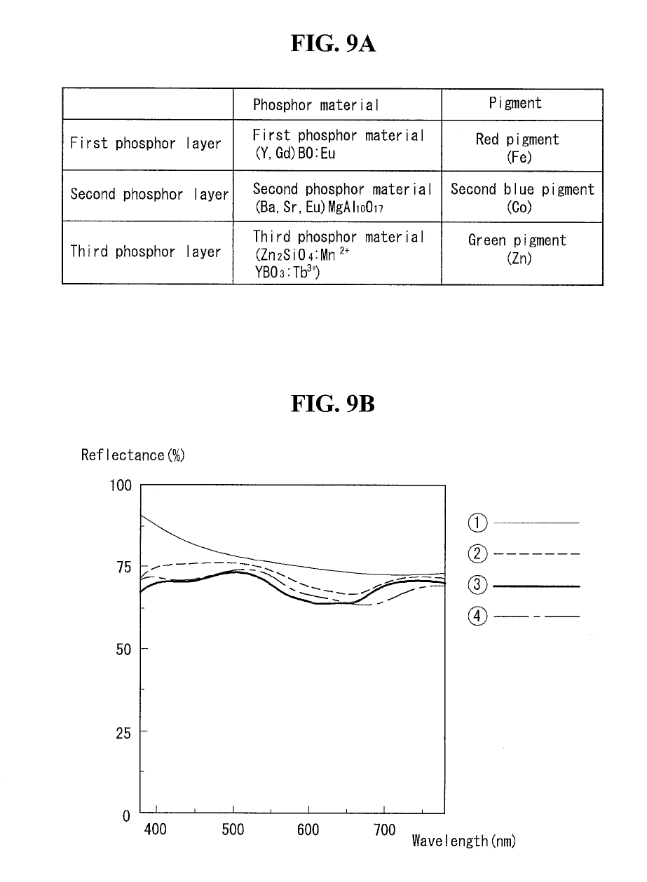

FIGS. 9A and 9B illustrate another implementation of a composition of a phosphor layer. A description in FIGS. 9A and 9B overlapping the description in FIG. 3 is briefly made or entirely omitted.

As illustrated in FIG. 9A, the third phosphor layer emitting green light include a third phosphor material having a white-based color arid a green pigment.

A description in FIG. 9A may be substantially the same as the description in FIG. 3 except that the third phosphor layer includes the green pigment.

The green pigment has a green-based color. The third phosphor layer may a green-based color by mixing the green pigment with the third phosphor material. The green pigment is not particularly limited except the green-based color. The green pigment may include a zinc (Zn) material in consideration of facility of powder manufacture, color, and manufacturing cost.

The Zn-based material may be in a state of zinc oxide, for instance, in a state of ZnCO₂O₄ in the third phosphor layer.

FIG. 9B is a graph showing a reflectance of a test model depending on a wavelength.

Similar to FIGS. 4A and 4B, a 7-inch test model on which a third phosphor layer emitting green light from all discharge cells is positioned is manufactured. Then, light is directly irradiated on a barrier rib and the third phosphor layer of the test model in a state where a front substrate of the test model is removed to measure a reflectance of the test model.

The third phosphor layer includes a third phosphor material and a green pigment. The third phosphor material includes Zn₂SiO₄:Mn⁺² and YBO₃:Tb⁺³ in a ratio of 5:5. The green pigment is a Zn-based material, and the Zn-based material in a state of ZnCO₂O₄ is mixed with the third phosphor material.

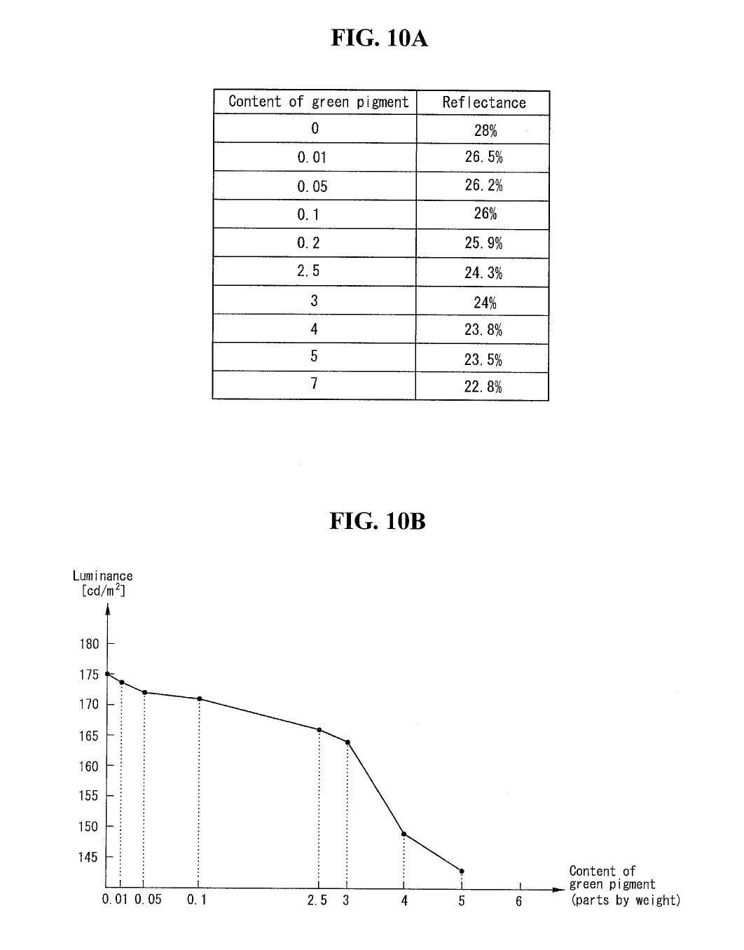

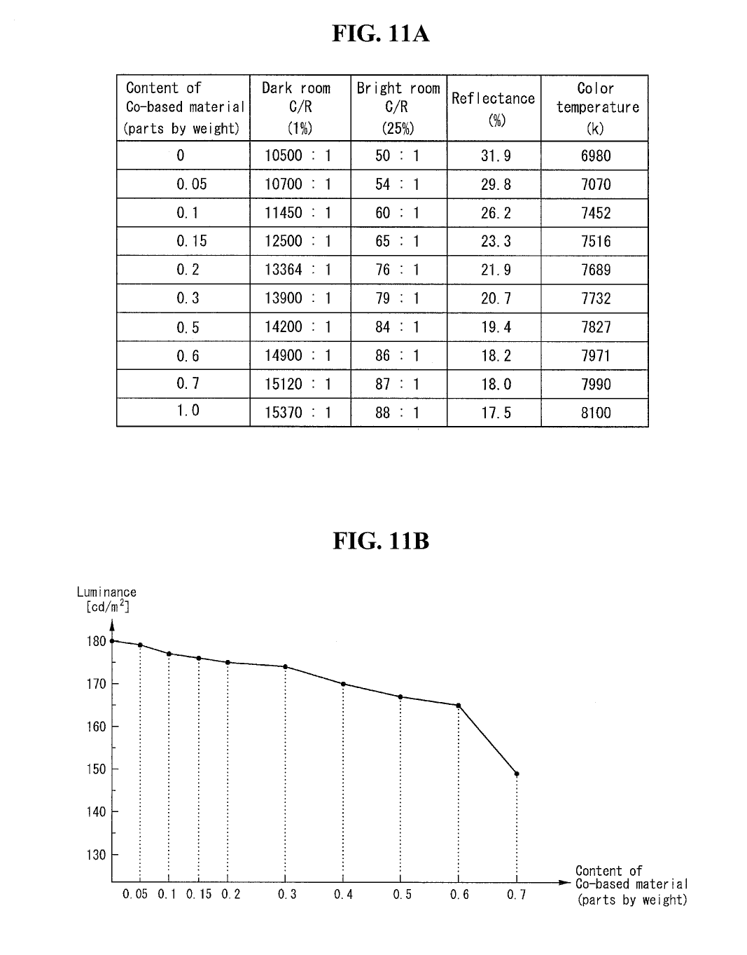

In FIG. 10B, \textcircled{1} indicates a case where the third phosphor layer does not include the green pigment. \textcircled{2} indicates a case where the third phosphor layer includes the green pigment of 0.1 part by weight. \textcircled{3} indicates a case where the third phosphor layer includes the green pigment of 0.5 part by weight. \textcircled{4} indicates a case where the third phosphor layer includes the green pigment of 1.0 part by weight.

In case of \textcircled{1} not including the green pigment, a reflectance is equal to or more than about 75% at a wavelength of 400 nm to 750 nm and is equal to or more than about 80% at a wavelength of 400 nm to 500 nm.

Because the third phosphor material having a white-based color reflects most of incident light, the reflectance in \textcircled{1} is high.

In case of \textcircled{2} including the green pigment of 0.1 part by weight, a reflectance is equal to or less than about 75% at a wavelength of 400 nm to 550 nm and ranges from about 66% to 70% at a wavelength of 550 nm to 700 nm.

In case of \textcircled{3} including the green pigment of 0.5 part by weight, a reflectance is equal to or less than about 73% at a wavelength of 400 nm to 550 nm and ranges from about 63% to 65% at a wavelength more than 550 nm.

In case of \textcircled{4} including the green pigment of 1.0 part by weight, a reflectance is similar to the reflectance in \textcircled{3} at a wavelength of 400 nm to 750 nm.

Because the green pigment having a green-based color absorbs incident light, the reflectances in \textcircled{2}, \textcircled{3} and \textcircled{4} are less than the reflectance in \textcircled{1}.

The fact that the reflectances in \textcircled{3} and \textcircled{4} are similar to each other means that a reduction width of the panel reflectance is small although a content of green pigment increases.

FIGS. 10A and 10B illustrate a reflectance and a luminance of a plasma display panel depending on changes in a content of green pigment, respectively,

In FIGS. 10A and 10B, the first phosphor layer is positioned inside the red discharge cell, the second phosphor layer is positioned inside the blue discharge cell, and the third phosphor layer is positioned inside the green discharge cell. Further, a reflectance and a luminance of the plasma display panel are measured depending on changes in a content of green pigment mixed with the third phosphor layer in a state where a second blue pigment of 1.0 part by weight is mixed with the second phosphor layer and the red pigment of 0.2 part by weight is mixed with the first phosphor layer. In this case, a reflectance and a luminance of the plasma display panel are measured in a panel state in which the front substrate and the rear substrate coalesce with each other.

The first phosphor material is (Y, Gd)BO:Eu. The red pigment is an Fe-based material, and the Fe-based material in a state of αFe₂O₃ is mixed with the first phosphor material.

The second phosphor material is (Ba, Sr, Eu)MgAl₁₀O₁₇. The second blue pigment is a Co-based material, and the Co-based material in a state of CoAl₂O₄ is mixed with the second phosphor material.

The third phosphor material includes Zn₂SiO₄:Mn⁺² and YBO₃:Tb⁺³ in a ratio of 5:5. The green pigment is a Zn-based material, and the Zn-based material in a state of ZnCO₂O₄ is mixed with the third phosphor material.

FIG. 10A is a table showing a reflectance at a wavelength of 550 nm.

As illustrated in FIG. 10A, when a content of green pigment is 0, a panel reflectance is a relatively high value of 28%.

When a content of green pigment is 0.01 part by weight, a panel reflectance is about 26.5%. When a content of green pigment is 0.05 part by weight, a panel reflectance is about 26.2%.

When a content of green pigment is 0.1 part by weight, a panel reflectance is about 26%. When a content of green pigment is 0.2 part by weight, a panel reflectance is about 25.9%.

When a content of green pigment greatly increases to 2.5 parts by weight, a panel reflectance falls to about 24.3%.

When a content of green pigment is 3 parts by weight, a panel reflectance is about 24%.

When a content of green pigment is 4, 5 and 7 parts by weight, respectively, a panel reflectance is about 23.8%, 23.5% and 22.8%, respectively.

As can be seen from FIG. 10A, when a content of green pigment is equal to or more than 4 parts by weight, a reduction width of the panel reflectance is small.

FIG. 10B is a graph showing a luminance of the same image depending on changes in a content of green pigment included in the third phosphor layer in a state where a content of each of the red pigment and the second blue pigment is fixed.

As illustrated in FIG. 10B, a luminance of an image displayed when the third phosphor layer does not include the green pigment is about 175 cd/m².

When a content of green pigment is 0.01 part by weight, a luminance of the image is reduced to about 174 cd/m². The reason why the green pigment reduces the luminance of the image is that particles of the green pigment cover a portion of the particle surface of the third phosphor material, thereby hindering ultraviolet rays generated by a discharge inside the discharge cell from being irradiated on the particles of the third phosphor material.

When a content of green pigment ranges from 0.05 to 2.5 parts by weight, a luminance of the image has a stable value of about 166 cd/m² to 172 cd/m².

When a content of green pigment is 3 parts by weight, a luminance of the image is about 164 cd/m².

When a content of green pigment is equal to or more than 4 parts by weight, a luminance of the image is sharply reduced to a value equal to or less than about 149 cd/m². In other words, when a large amount of green pigment is mixed, the particles of the green pigment cover a large area of the particle surface of the third phosphor material and thus the luminance is sharply reduced.

Considering the description of FIGS. 10A and 10B, a content of green pigment may range from 0.01 to 3 parts by weight so as to prevent a reduction in the luminance while the panel reflectance is reduced. A content of green pigment may range from 0.05 to 2.5 parts by weight.

A reduction width in the panel reflectance when a content of green pigment increases is smaller than a reduction width in the panel reflectance when the red pigment and the second blue pigment are mixed. Accordingly, a content of green pigment may be smaller than a content of each of the red pigment and the second blue pigment. Further, the green pigment may not be mixed.

When the upper dielectric layer includes an excessively large amount of Co-based material as a first blue pigment, a transmittance of the upper dielectric layer is reduced and thus a luminance of a displayed image is excessively reduced. On the other hand, when the upper dielectric layer includes an excessively small amount of Co-based material, an increase width of a color temperature is small.

Further, when the amount of Co-based material is constant, a reflectance is lowered due to an increase in a thickness of the upper dielectric layer and thus a contrast characteristic is improved. However, a transmittance of the upper dielectric layer is lowered and thus a luminance of a displayed image is lowered. When the thickness of the upper dielectric layer is constant, a reflectance is lowered due to an increase in the amount of Co-based material and thus a contrast characteristic is improved. However, a transmittance of the upper dielectric layer is lowered and thus a luminance of a displayed image is lowered.

Accordingly, the thickness of the upper dielectric layer may be determined depending on the amount of Co-based material so as to raise the transmittance of the upper dielectric layer while the reflectance is lowered.

FIG. 11A is a table measuring a dark room contrast ratio, a bright room contrast ratio, a reflectance and a color temperature of the panel when a content of Co-based material used as a first blue pigment included in the upper dielectric layer is 0, 0.05, 0.1, 0.15, 0.2, 0.3, 0.5, 0.6, 0.7, and 1.0 part by weight, respectively. FIG. 11B is a graph showing a luminance of the panel under the same conditions as FIG. 11A. A thickness of the upper dielectric layer is fixed to 38 μm, and a first phosphor layer includes a red pigment of 0.2 part by weight.

The dark room contrast ratio measures a contrast ratio in a state where an image with a window pattern corresponding to 1%of the screen size is displayed in a dark room.

The bright room contrast ratio measures a contrast ratio in a state where an image with a window pattern corresponding to 25% of the screen size is displayed in a bright room.

As illustrated in FIG. 11A, when the upper dielectric layer does not include Co-based material, a dark room contrast ratio is 10500:1, a bright room contrast ratio is 50:1, a reflectance is 31.9%, and a color temperature is 6980K.

When the content of Co-based material is 0.05 part by weight, the dark room contrast ratio is 10700:1, the bright room contrast ratio is 54:1, the reflectance is 29.8%, and the color temperature is 7070K.

As above, when the upper dielectric layer includes a small amount of Co-based material equal to or less than 0.05 part by weight, the contrast ratio is reduced, the reflectance is high, and the color temperature is low.

When the content of Co-based material is 0.1 part by weight, the dark room contrast ratio is 11450:1, the bright room contrast ratio is 60:1, the reflectance is 26.2%, and the color temperature is 7452K. In other words, as the content of Co-based material increases, the contrast ratio increases, the reflectance is reduced, and the color temperature increases.

The upper dielectric layer has a blue-based color due to the properties of the Co-based material, and thus can absorb light coming from the outside. Hence, the contrast characteristic is improved and the reflectance is reduced.

Further, when visible light coming from the inside of the panel is emitted to the outside of the panel through the upper dielectric layer having a blue-based color, blue visible light can be more clearly emitted due to the upper dielectric layer. Hence, the color temperature can be improved.

When the content of Co-based material ranges from 0.15 to 0.3 part by weight, the dark room contrast ratio ranges from 12500:1 to 13900:1, the bright room contrast ratio ranges from 65:1 to 79:1, the reflectance ranges from 20.7% to 23.3%, and the color temperature ranges from 7516K to 7732K. In other words, when the content of Co-based material ranges from 0.15 to 0.3 part by weight, the contrast ratio, the reflectance and the color temperature can be improved.

When the content of Co-based material is equal to or more than 0.5 part by weight, the dark room contrast ratio is equal to or more than 14200:1, the bright room contrast ratio is equal to or more than 84:1, the reflectance is equal to or less than 19.4%, and the color temperature is equal to or more than 7827K.

As illustrated in FIG. 11B, when the upper dielectric layer does not include the Co-based material, a luminance of a displayed image is about 180 cd/m².

When the content of Co-based material is 0.05 part by weight, the luminance is reduced to about 179 cd/m². Because the upper dielectric layer has a blue-based color due to the Co-based material, a transmittance of the upper dielectric layer is reduced and thus the luminance is reduced.

When the content of Co-based material is 0.1 part by weight, the luminance is about 177 cd/m². When the content of Co-based material ranges from 0.15 to 0.3 part by weight, the luminance ranges from about 174 to 176 cd/m².

When the content of Co-based material ranges from 0.4 to 0.6 part by weight, the luminance ranges from about 165 to 170 cd/m².

When the upper dielectric layer includes a large amount of Co-based material equal to or more than 0.7 part by weight, the transmittance of the upper dielectric layer is excessively reduced. Hence, the luminance is sharply reduced to a value equal to or less than about 149 cd/m².

Considering the description of FIGS. 11A and 11B, the content of Co-based material used as the first blue pigment may range from 0.01 to 0.6 part by weight so as to prevent a reduction in the luminance caused by an excessive reduction in the transmittance of the upper dielectric layer while the reflectance is reduced and the contrast ratio and the color temperature increase. Further, the content of Co-based material may range from 0.15 to 0.3 part by weight.

The first blue pigment may include at least one of a Cu-based material, a Cr-based material, a Ni-based material, an Al-based material, a Ti-based material, a Ce-based material, a Mn-based material or an Nd-based material, in addition to the Co-based material used as a main material.

In case that the Ni-based material is added to the Co-based material, the upper dielectric layer may be dark blue. Therefore, an image of dark blue can be more clearly displayed on the screen. When an excessively large amount of Ni-based material is added, the transmittance of the upper dielectric layer can be excessively reduced. Therefore, a content of Ni-based material may range from 0.1 to 0.2 part by weight.

In case that the Cr-based material is added to the Co-based material, the upper dielectric layer may have a mixed color of red and blue. Therefore, an image with the mixed color can be more clearly displayed on the screen. In other words, a color representable range of the image can increase. A content of Cr-based material may range from 0.1 to 0.3 part by weight.

In case that the Cu-based material is added to the Co-based material, the upper dielectric layer may have a mixed color of green and blue. Therefore, an image with the mixed color can be more clearly displayed on the screen. In other words, a color representable range of the image can increase. A content of Cu-based material may range from 0.03 to 0.09 part by weight.

In case that the Ce-based material is added to the Co-based material, the upper dielectric layer may have a mixed color of yellow and blue. Therefore, an image with the mixed color can be more clearly displayed on the screen. In other words, a color representable range of the image can increase. A content of Ce-based material may range from 0.1 to 0.3 part by weight.

In case that the Mn-based material is added to the Co-based material, a blue color of the upper dielectric layer may be deep. Therefore, a color temperature of a displayed image can increase. A content of Mn-based material may range from 0.2 to 0.6 part by weight.

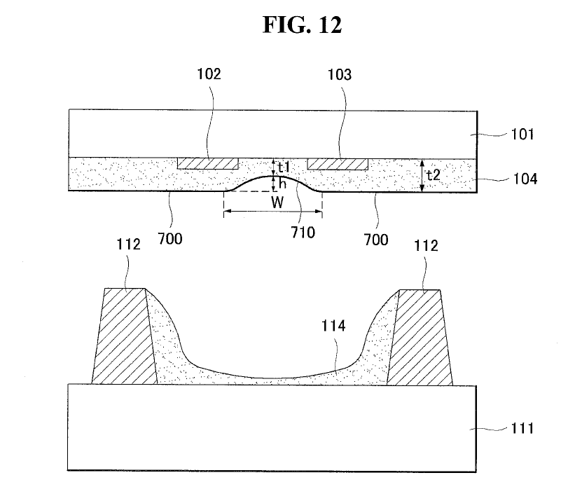

FIG. 12 illustrates another structure of an upper dielectric layer.

As illustrated in FIG. 12, the upper dielectric layer 104 includes a convex portion 700 and a concave portion 710 with a thickness smaller than a thickness of the convex portion 700.

The concave portion 710 may be positioned between the scan electrode 102 and the sustain electrode 103.

A largest thickness of the upper dielectric layer 104 (i.e., a thickness of the upper dielectric layer 104 in the convex portion 700) is t2, and a thickness of the upper dielectric layer 104 in the concave portion 710 is t1. A depth of the concave portion 710 is h, and a width of the concave portion 710 is W.

When a discharge occurs by applying a driving signal to the scan electrode 102 and the sustain electrode 103, most of wall charges may be accumulated on the concave portion 710. Therefore, a discharge path can shorten due to the structure of the upper dielectric layer 104 of FIG. 12. As a result, a firing voltage between the scan electrode 102 and the sustain electrode 103 is lowered and thus the driving efficiency can be improved.

A transmittance of the upper dielectric layer 104 with a blue-based color by including a Co-based material is smaller than a transmittance of the transparent upper dielectric layer 104 not including the Co-based material. Hence, a luminance of a displayed image may be reduced.

On the contrary, as illustrated in FIG. 12, when the upper dielectric layer 104 includes the convex portion 700 and the concave portion 710, a firing voltage between the scan electrode 102 and the sustain electrode 103 can be lowered and thus a reduction in the luminance caused by the Co-based material can be compensated.

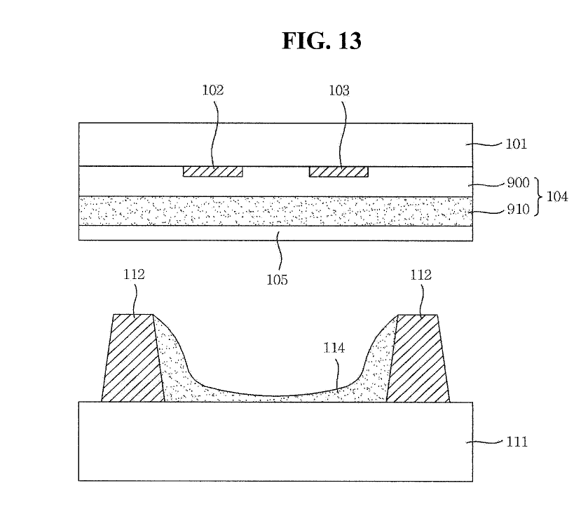

FIG. 13 illustrates another structure of an upper dielectric layer.

As illustrated in FIG. 13, the upper dielectric layer 104 has a two-layered structure. For instance, the upper dielectric layer 104 includes a first upper dielectric layer 900 and a second upper dielectric layer 910 which are stacked in turn.

At least one of the first upper dielectric layer 900 or the second upper dielectric layer 910 may include a first blue pigment. If the upper dielectric layer 104 includes a first blue metal pigment, a permittivity of the upper dielectric layer 104 may be reduced.

It is advantageous that a permittivity of the first upper dielectric layer 900 is relatively high because the first upper dielectric layer 900 covers the scan electrode 102 and the sustain electrode 103 and provides insulation between the scan electrode 102 and the sustain electrode 103. Therefore, the first upper dielectric layer 900 may not include a first blue pigment, and the second upper dielectric layer 910 positioned on the first upper dielectric layer 900 may include a pigment.

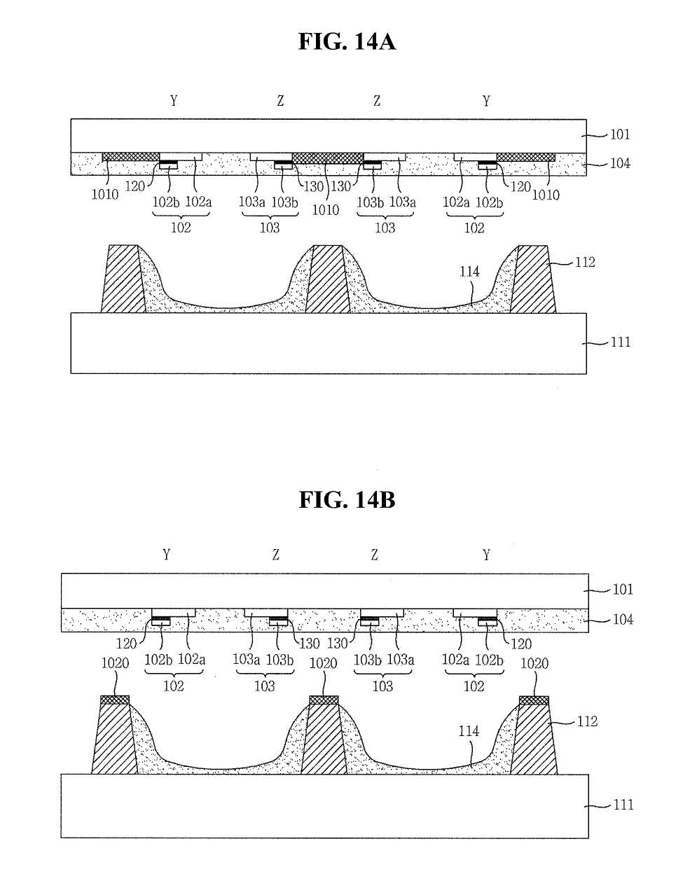

FIGS. 14A and 14B illustrate another structure of the plasma display panel according to the exemplary embodiment.

As illustrated in FIG. 14A, a black matrix 1010 overlapping the barrier rib 112 is positioned on the front substrate 101. The black matrix 1010 absorbs incident light, and thus suppresses the reflection of light caused by the barrier rib 112. Hence, a panel reflectance is reduced and a contrast characteristic can be improved.

In FIG. 14A, the black matrix 1010 is positioned on the front substrate 101. However, the black matrix 1010 may be positioned on the upper dielectric layer (not shown).

Black layers 120 and 130 are positioned between the transparent electrodes 102a and 103a and the bus electrodes 102b and 103b, respectively. The black layers 120 and 130 prevent the reflection of light caused by the bus electrodes 102b and 103b, thereby reducing a panel reflectance

As illustrated in FIG. 14B, a top black matrix 1020 is formed on the barrier rib 112. Since the top black matrix 1020 reduces a panel reflectance, a black matrix may not be formed on the front substrate 101.

As described above, when the upper dielectric layer 104 includes a first blue pigment and the first phosphor layer includes a red pigment, the panel reflectance can be further reduced.

The black layers 120 and 130, the black matrix 1010 and the top black matrix 1020 may be omitted from the plasma display panel. Because the first blue pigment mixed with the upper dielectric layer 104 or the red pigment mixed with the first phosphor layer can sufficiently reduce the panel reflectance, a sharp increase in the panel reflectance can be prevented although the black layers 120 and 130, the black matrix 1010 and the top black matrix 1020 are omitted.

A removal of the black layers 120 and 130, the black matrix 1010 and the top black matrix 1020 can make a manufacturing process of the panel simpler, and reduce the manufacturing cost.

A width of at least one of the black matrix 1010 of FIG. 14A or the top black matrix 1020 of FIG. 14B may be smaller than an upper width of the barrier rib 112. In this case, an aperture ratio can be sufficiently secured and an excessive reduction in a luminance can be prevented.

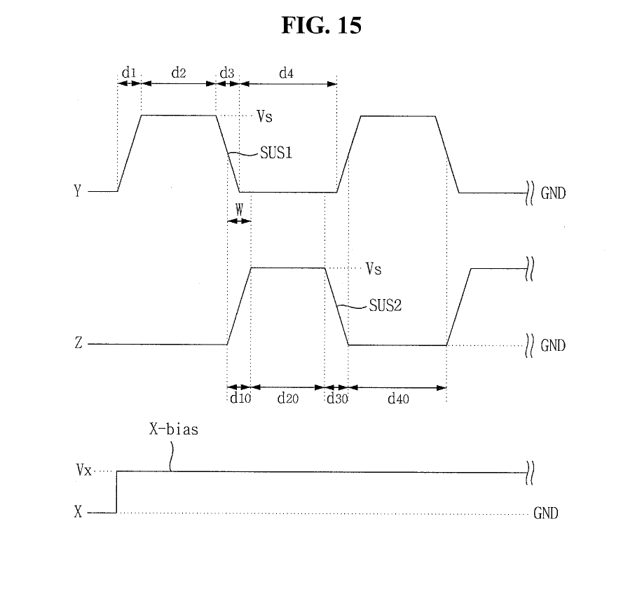

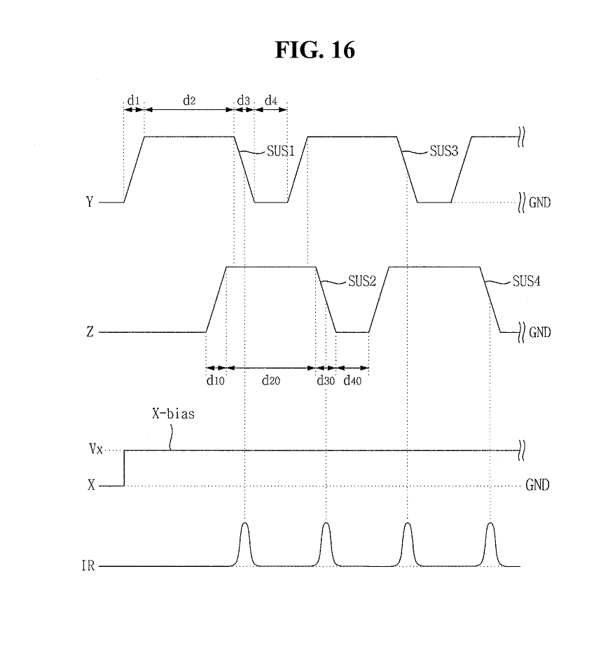

FIG. 15 is a diagram for explaining the overlap of sustain signals.

As illustrated in FIG. 15, a first sustain signal SUS1 and a second sustain signal SUS2 are alternately supplied to the scan electrode Y and the sustain electrode Z. The first sustain signal SUS1 and the second sustain signal SUS2 may overlap each other.

The first sustain signal SUS1 includes a voltage rising period d1, a first voltage maintenance period d2 during which the first sustain signal SUS1 is maintained at a highest voltage Vs, a voltage falling period d3, and a second voltage maintenance period d4 during which the first sustain signal SUS1 is maintained at a lowest voltage GND. The second sustain signal SUS2 includes a voltage rising period d10, a first voltage maintenance period d20 during which the second sustain signal SUS2 is maintained at a highest voltage Vs, a voltage falling period d30, and a second voltage maintenance period d40 during which the second sustain signal SUS2 is maintained at a lowest voltage GND. The voltage falling period d3 of the first sustain signal SUS1 may overlap the voltage rising period d10 of the second sustain signal SUS2.

When two successively applied sustain signals overlap each other, the number of sustain signals capable of being applied during a sustain period can increase. Hence, a luminance can be improved. Further, when the phosphor layer or the upper dielectric layer includes a pigment, the overlap of the sustain signals can compensate for a reduction in a luminance caused by the pigment.

An address bias signal X-Bias, which is maintained at a voltage Vx higher than the ground level voltage GND, is supplied to the address electrode X during the sustain period. Hence, a voltage difference between the scan electrode Y and the address electrode X and a voltage difference between the sustain electrode Z and the address electrode X can be reduced during the sustain period. Furthermore, a sustain discharge between the scan electrode Y and the sustain electrode Z can occur close to the front substrate. The efficiency of the sustain discharge can be improved and a degradation of the phosphor layer can be suppressed.

FIG. 16 is a diagram for explaining a first maintenance period and a second maintenance period.

As illustrated in FIG. 16, the voltage falling period d3 of the first sustain signal SUS1 may overlap the first voltage maintenance period d20 of the second sustain signal SUS2.

A sustain discharge may occur due to an increase in a voltage difference between the scan electrode and the sustain electrode during the voltage falling periods d3 and d30 of the first and second sustain signals SUS1 and SUS2.

Further, a sustain discharge may occur due to an increase in a voltage difference between the scan electrode and the sustain electrode during the voltage rising periods d1 and d10 of the first and second sustain signals SUS1 and SUS2. In this case, a self-erase discharge may frequently occur due to electrons moving from the phosphor layer in a direction toward the scan electrode or the sustain electrode, and thus wall charges accumulated on the scan electrode or the sustain electrode may be erased. Hence, the sustain discharge may unstably occur due to the insufficient amount of wall charges. The self-erase discharge may more frequently occur due to an increase in an interference of the phosphor layer when an interval between the scan electrode and the sustain electrode is relatively wide, for instance, when an interval between the scan electrode and the sustain electrode is larger than a height of the barrier rib.

On the contrary, when a sustain discharge occurs due to an increase in the voltage difference between the scan electrode and the sustain electrode during the voltage falling periods d3 and d30, the sustain discharge occurs due to electrons moving from the scan electrode or the sustain electrode to a direction toward the phosphor layer. Hence, a self-erase discharge can be suppressed. The generation of the self-erase discharge can be suppressed although the interval between the scan electrode and the sustain electrode is larger than the height of the barrier rib.

As above, a time width of each of the first voltage maintenance periods d2 and d20 may be longer than a time width of each of the second voltage maintenance periods d4 and d40 so as to increase the voltage difference between the scan electrode and the sustain electrode during the voltage falling periods d3 and d30. Hence, the voltage falling period d3 can overlap the first voltage maintenance period d20, and thus sustain discharge can occur during the voltage falling period d3. Further, the self-erase discharge can be suppressed.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display panel comprising:
a front substrate;
a scan electrode and a sustain electrode positioned parallel to each other on the front substrate;
an upper dielectric layer positioned on the scan electrode and the sustain electrode, the upper dielectric layer including a glass-based material and a first blue pigment;
a rear substrate positioned to be opposite to the front substrate;
a barrier rib that is positioned between the front substrate and the rear substrate and partitions a discharge cell; and
a phosphor layer positioned inside the discharge cell, the phosphor layer including a first phosphor layer emitting red light, a second phosphor layer emitting blue light, and a third phosphor layer emitting green light, the first phosphor layer including a red pigment.

2. The plasma display panel of claim 1, wherein the red pigment includes an iron (Fe)-based material,

3. The plasma display panel of claim 1, wherein a content of red pigment ranges from 0.01 to 5 parts by weight.

4. The plasma display panel of claim 1, wherein the second phosphor layer includes a second blue pigment, and a content of second blue pigment ranges from 0.01 to 5 parts by weight.

5. The plasma display panel of claim 4, wherein the second blue pigment includes at least one of a cobalt (Co)-based material, a copper (Cu)-based material, a chrome (Cr)-based material, a nickel (Ni)-based material, an aluminum (Al)-based material, a titanium (Ti)-based material, a cerium (Ce)-based material, a manganese (Mn)-based material or a neodymium (Nd)-based material.

6. The plasma display panel of claim 1, wherein the third phosphor layer includes a green pigment, and a content of green pigment ranges from 0.01 to 3 parts by weight.

7. The plasma display panel of claim 6, wherein the green pigment includes a zinc (Zn)-based material.

8. The plasma display panel of claim 7, wherein a content of green pigment is smaller than a content of red pigment.

9. The plasma display panel of claim 4, wherein the first blue pigment includes at least one of a cobalt (Co)-based material, a copper (Cu)-based material, a chrome (Cr)-based material, a nickel (Ni)-based material, an aluminum (Al)-based material, a titanium (Ti)-based material, a cerium (Ce)-based material, a manganese (Mn)-based material or a neodymium (Nd)-based material.

10. The plasma display panel of claim 1, wherein a content of first blue pigment ranges from 0.1 to 0.6 part by weight.

11. The plasma display panel of claim 1, wherein a color of the first phosphor layer is different from a color of the second phosphor layer.

12. The plasma display panel of claim 1, wherein the first phosphor layer has a red-based color, and the upper dielectric layer has a blue-based color.

13. A plasma display panel comprising:
a front substrate;
a scan electrode and a sustain electrode positioned parallel to each other on the front substrate;
an upper dielectric layer positioned on the scan electrode and the sustain electrode, the upper dielectric layer including a glass-based material and a Co-based material;
a rear substrate positioned to be opposite to the front substrate;
a barrier rib that is positioned between the front substrate and the rear substrate arid partitions a discharge cell; and
a phosphor layer positioned inside the discharge cell, the phosphor layer including a first phosphor layer emitting red light, a second phosphor layer emitting blue light, and a third phosphor layer emitting green light, the first phosphor layer including an iron (Fe)-based material.

14. The plasma display panel of claim 13, wherein a content of Fe-based material ranges from 0.01 to 5 parts by weight.

15. The plasma display panel of claim 13, wherein a content of Co-based material ranges from 0.1 to 0.6 part by weight.

16. A plasma display apparatus comprising:
a front substrate including a scan electrode and a sustain electrode positioned parallel to each other;
an upper dielectric layer positioned on the scan electrode and the sustain electrode, the upper dielectric layer including a glass-based material and a first blue pigment;
a rear substrate on which an address electrode is positioned to intersect the scan electrode and the sustain electrode;
a lower dielectric layer positioned on the address electrode;
a barrier rib that is positioned between the front substrate and the rear substrate and partitions a discharge cell; and
a phosphor layer positioned inside the discharge cell, the phosphor layer including a first phosphor layer emitting red light, a second phosphor layer emitting blue light, and a third phosphor layer emitting green light, the first phosphor layer including a red pigment,
wherein a first sustain signal is supplied to the scan electrode and a second sustain signal overlapping the first sustain signal is supplied to the sustain electrode during a sustain period of at least one subfield of a frame.

17. The plasma display apparatus of claim 16, wherein the first sustain signal and the second sustain signal each include a voltage rising period, a first voltage maintenance period during which the first and second sustain signals are maintained at a highest voltage, a voltage falling period, and a second voltage maintenance period during which the first and second sustain signals are maintained at a lowest voltage, and the voltage falling period of the first sustain signal overlaps the voltage rising period of the second sustain signal.

18. The plasma display apparatus of claim 16, wherein the first sustain signal and the second sustain signal each include a voltage rising period, a first voltage maintenance period during which the first and second sustain signals are maintained at a highest voltage, a voltage falling period, and a second voltage maintenance period during which the first and second sustain signals are maintained at a lowest voltage, and
a voltage difference between the scan electrode and the sustain electrode increases during the voltage falling periods of the first and second sustain signals.

19. The plasma display apparatus of claim 16, wherein the first sustain signal and the second sustain signal each include a voltage rising period, a first voltage maintenance period during which the first and second sustain signals are maintained at a highest voltage, a voltage falling period, and a second voltage maintenance period during which the first and second sustain signals are maintained at a lowest voltage, and
a time width of the first voltage maintenance period of each of the first and second sustain signals is longer than a time width of the second voltage maintenance period of each of the first and second sustain signals.

20. The plasma display apparatus of claim 16, wherein an address bias signal maintained at a voltage level higher than a ground level voltage is supplied to the address electrode during the sustain period.
